(19) United States
(12) Patent Application Publication
(10) Pub. No.: US 2006/0074770 A1
(43) Pub. Date: Apr. 6, 2006

(54) Video delivery system and related method

(75) Inventors: Khalid Oreif, La Canada, CA (US); Lisa Gregorian, Studio City, CA (US); Kim-Ming Lau, Temple City, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Warner Bros. Entertainment Inc.

(21) Appl. No.: 11/210,267

(22) Filed: Aug. 22, 2005

Related U.S. Application Data
(60) Provisional application No. 60/603,494, filed on Aug. 20, 2004.

(51) Int. Cl. G06Q 30/00

(52) U.S. Cl. 705/26

(57) ABSTRACT

A system that includes a server that is configured to be coupled to the Internet, a monitor, and a video appliance that is coupled to the monitor and configured to be coupled to the Internet. The server stores a media element, and the monitor is configured to display a copy of the media element. The server is configured to transmit the copy of the media element to the video appliance via the Internet. The video appliance is configured to receive the copy of the media element, and to prompt the monitor to display the copy of the media element for viewing by a user.

### CROSS-REFERENCE TO RELATED APPLICATION

Priority is claimed under 35 U.S.C. § 119(e) to U.S. Provisional Patent Application No. 60/603,494, filed on Aug. 20, 2004, entitled “Video Delivery System and Related Method,” by Khalid Oreif, Lisa Gregorian, and Kim-Ming Lau, which application is incorporated by reference herein.

### BACKGROUND OF THE INVENTION

1. Field of the Invention

The invention relates generally to the field of video/media/assets distribution. More specifically, the invention relates to the delivery of video/assets/media via a network to set-top box connected to a television and operated by a consumer-based remote control. The user interaction and behaviors are captured back from the set-top box and sent to servers for analysis and data mining.

2. Description of the Related Art

Currently, screeners, i.e., sample media elements sent to a user for review, e.g., clips, trailers, other video materials, and digital assets, are distributed to end viewers on digital video discs (“DVDs”). However, DVDs are not ideal delivery media because DVDs are subject to theft and copying. Accordingly, there is a need for secure system for the delivery of screeners to end viewers. The present invention satisfies this need, as well as other needs as discussed below.

### SUMMARY OF THE INVENTION

Embodiments of the present invention include a system and related method for the delivery of video that is secure and low in cost. An exemplary embodiment of the present invention is a system that is configured to be coupled to the Internet. The system includes a server that is configured to be coupled to the Internet, a monitor, and a video appliance that is coupled to the monitor and also configured to be coupled to the Internet. The server stores a media element, and the monitor is configured to display a copy of the media element. The server is configured to transmit the copy of the media element to the video appliance via the Internet. The video appliance is configured both to receive the copy of the media element and to prompt the monitor to display the copy of the media element for viewing by a user.

In other, more detailed features of the invention, the media element is selected from the group consisting of a feature movie, a movie promotion, a movie trailer, and a video clip associated with a television program. Also, in additional embodiments, the system includes a remote control that is configured to communicate with the video appliance. The user can use the remote control to perform a task selected from the group consisting of playing the copy of the media element, pausing the display of the copy of the media element, fast forwarding the display of the copy of the media element, rewinding the display of the copy of the media element, stopping the display of the copy of the media element, and selecting a copy of another media element for display on the monitor.

In other, more detailed features of the invention, the video appliance is configured to prompt the monitor to display a screen that includes a graphical user interface. The user can utilize the graphical user interface to select the copy of the media element for viewing or deletion. The graphical user interface can include an icon that is associated with the copy of the media element. Also, the graphical user interface can include information selected from the group consisting of a description of the media element, a title of the media element, a runtime of the media element, a genre of the media element, and a date associated with the media element.

In other, more detailed features of the invention, the video appliance stores information related to the user's viewing behavior for each copy of a media element viewed by the user. The information related to the user's viewing behavior can be selected from the group consisting of a name of the media element that was selected by the user for display on the monitor, a time when the copy of the media element was displayed on the monitor, a time when the display of the copy of the media element was paused, and a time when the display of the copy of the media element was stopped.

In other, more detailed features of the invention, the video appliance transmits the information related to the user's viewing behavior of the copy of the media element to the server via the Internet. The server can receive and store the information related to the user's viewing behavior of the copy of the media element. A data analyst then can examine the information stored in the server related to the user's viewing behavior of the copy of the media element, and generate a report based on the information related to the user's viewing behavior of the copy of the media element.

In other, more detailed features of the invention, the system can further include a system administrator computer that is coupled to the Internet and that is used by a system administrator to control the access of the video appliance to a copy of the media element that is stored in the server. The system administrator can use the system administrator computer to perform a task selected from the group consisting of storing a new media element in the server, creating a new media element, modifying a media element that is already stored in the server, deleting a media element that was stored in the server, creating a user account, updating a user account, disabling a user account, and managing a user's access to a copy of a media element that is stored in the server. Also, the system can further include a security feature selected from the group consisting of security management, authentication, and encryption that is used to protect the copy of the media element from piracy during the transmission of the copy of the media element from the server to the video appliance.

In other, more detailed features of the invention, the server and/or the system administrator computer are configured to transmit a patch to the video appliance, and the video appliance is configured to automatically apply the patch. Also, the video appliance can include a heartbeat mechanism, and the server and/or system administrator computer can be configured to sense the heartbeat mechanism.

Another exemplary embodiment of the present invention is a system that includes a server that is configured to be coupled to a network, a monitor, and a video appliance that is coupled to the monitor and also configured to be coupled to the network. The server stores a media element, and the monitor is configured to display a copy of the media element. The server is configured to transmit a copy of the media element to the video appliance via the network. The video appliance is configured to receive the copy of the media element, and to prompt the monitor to display a screen that includes a graphical user interface. The graphical user interface is configured to be utilized by a user to select the copy of the media element for display on the monitor. The video appliance is configured to prompt the monitor to display the selected copy of the media element for viewing by the user. The video appliance is configured to store information related to the user's viewing behavior of the copy of the media element. The video appliance also is configured to transmit the information related to the user's viewing behavior of the copy of the media element to the server via the network. In other, more detailed features of the invention, the network is the Internet.

An exemplary method according to the invention is a method for the delivery of a copy of a media element via the Internet. The method includes providing a server that stores the media element and that is coupled to the Internet; providing a monitor; providing a video appliance that is coupled between the Internet and the monitor; using the server to generate a copy of the media element; transmitting the copy of the media element from the server to the video appliance via the Internet; and using the video appliance to prompt the monitor to display the copy of the media element on the monitor for viewing by a user.

In other, more detailed features of the invention, the method further includes providing a remote control that is configured to communicate with the video appliance, and using the remote control to select the copy of the media element to be displayed on the monitor. Also, the method further includes displaying a screen on the monitor that includes a graphical user interface, and using the graphical user interface to select the copy of the media element that is to be displayed on the monitor. In addition, the screen can include a hidden configuration menu that is accessible by a field officer.

In other, more detailed features of the invention, the method further includes storing information related to the user's viewing behavior for each copy of a media element that is displayed on the monitor. Also, the method further includes transmitting the information related to the user's viewing behavior for each copy of a media element from the video appliance to the server.

In other, more detailed features of the invention, the method further includes analyzing the information related to the user's viewing behavior for each copy of a media element that is transmitted from the video appliance to the server. Also, the method further includes generating reports using the information related to the user's viewing behavior for each copy of a media element that is transmitted from the video appliance to the server. In addition, the method further includes using the server to authenticate the video appliance before transmitting the copy of the media element from the server to the video appliance.

Other features of the invention should become apparent from the following description of the preferred embodiments taken in conjunction with the accompanying drawings, which illustrate, by way of example, the principles of the invention.

### BRIEF DESCRIPTION OF THE DRAWINGS

FIG. 1 is a block diagram of a video delivery system according to the present invention.

FIG. 2 is a block diagram of a user communicating with a set-top box included in the video delivery system.

FIG. 3 is a block diagram of a user browsing and selecting a screener for viewing using the video delivery system.

FIG. 4 is a top plan view of a remote control included in the video delivery system.

FIG. 5 is a printout of a “Pick of The Week” screen that is displayed on the set-top box.

FIG. 6 is a printout of an “Information Page” screen that is displayed on the set-top box.

FIG. 7 is a block diagram of the communication process between the set-top box and a server included in the video delivery system.

FIG. 8 is block diagram of the download processes from the server to the set-top box.

FIG. 9 is a block diagram of the data collection process from a user to a reporting tool system included in the video delivery system.

FIG. 10 is a block diagram of the data communication process between a data analyst and the reporting tool system.

FIG. 11 is a block diagram of the data communication process between a developer and the reporting tool system.

FIG. 12 is a block diagram of an administrator tracking a user's viewing pattern using the video delivery system.

FIG. 13 is a block diagram of the communication process between the administrator and the server.

FIG. 14 is a block diagram of the communication process between the administrator and a data management system included in the video delivery system when the administrator creates, modifies, deletes, and/or links content.

FIG. 15 is a printout of an example screen displaying a message to the user of the video delivery system.

FIG. 16 is a block diagram of the communication process between the administrator and the data management system when the administrator creates, modifies, deletes, or disables a user.

FIG. 17 is a block diagram of the communication process between the administrator and the data management system when the administrator provides user permission to content.

### DETAILED DESCRIPTION OF THE PREFERRED EMBODIMENTS

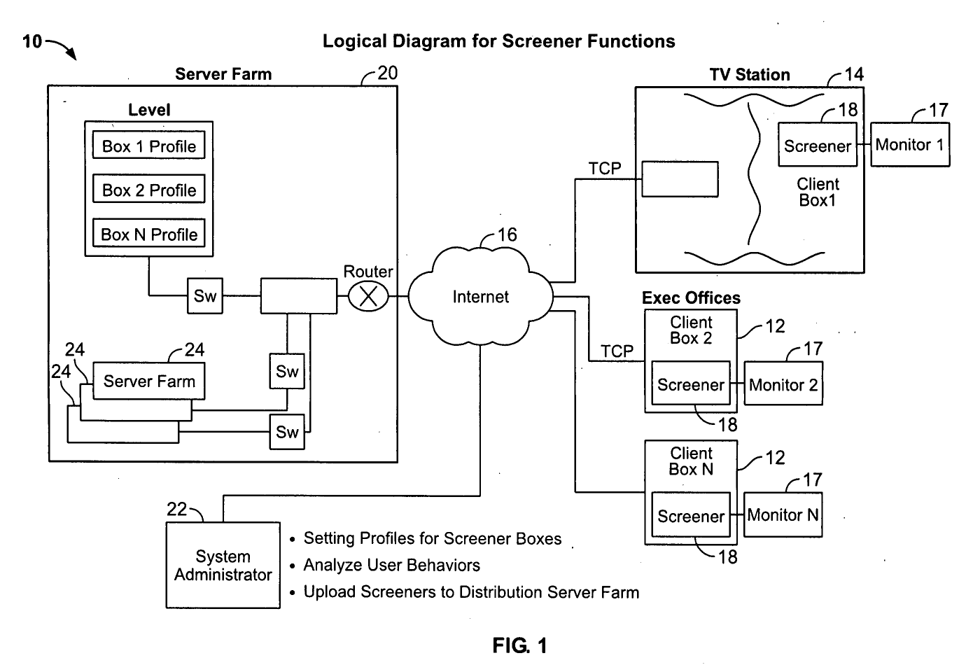

As shown in the block diagram of FIG. 1, embodiments of the present invention are video delivery systems 10 that provides users, e.g., executives 12, television (“TV”) stations 14, business partners (not shown), and raters (not shown), with an easy-to-use, in-office/home video delivery system for accessing screeners, i.e., sample media element sent to a user for review, e.g., clips, trailers, other video materials, and digital assets. The video delivery system tracks the user's behavior and selections to provide both pre-sale and post-sale data related to the screeners. The screeners are distributed via a network 16, e.g., the Internet, for display on a TV or other monitor 17, using a set-top box 18 operated with a remote control (not shown). The set-top box is a video hardware appliance that is configured to download the screener and present the user with a GUI on the television to navigate and play the screener. The set-top box is customized to accommodate the heavy demands of broadcast quality video and configured for future expansion. Embodiments of the set-top box are internet protocol-based (“IP-based”).

In the embodiment depicted in FIG. 1, the video delivery system 10 includes a server farm 20 that is coupled via the Internet 16 to a system administrator computer (“system administrator”) 22, to a TV station 14, and to executive offices 12. The server farm, also known as the server or screener server cluster, includes one or more computers 24, e.g., Sun Unix computers, with enough disk storage to hold screener media files. The servers run Java-based network applications to serve the set-top box users. Part of the server functionality of this cluster includes: accepting network connections from the set-top box 18, checking the set-top boxes' RSA key to authenticate the set-top boxes, checking a database stored in the server for outstanding files to transfer to a set-top box, collecting traffic information from the set-top box, and sending pending client software updates (if any) to the set-top box.

The video delivery system 10 according to the present invention uses the Internet 16, instead of satellite transmission, as the distribution infrastructure. Thus, the video delivery system incorporates a public distribution mechanism, which is likely lower in cost than private distribution mechanisms. Additional advantages that may accrue from using the Internet include obviating satellite antennae and overcoming a possible lack of satellite signal coverage in some potential reception sites. The system according to the present invention also allows targeting contents for different users based on each user's profile, and based on feedback regarding the user's explicit and implicit actions. Additionally, the system incorporates security management, authentication, and encryption to secure the screener content from piracy.

The video delivery system 10 tracks a user's explicit and implicit behavior to provide feedback on the attractiveness of the offered screener content. Information such as user selections, when the screener was played, and at what point the screener was paused and stopped are relayed back to the screener server cluster. After analyzing this information, future screeners can be tailored to the end users needs. Thus, the present invention can provide a more attractive, and possibly a more lucrative, service to the end users. A database, e.g., an Oracle relational database management system (“RDBMS”), that is stored in the screener server cluster 20 stores user profiles, screener subscriptions, and meta-data and tracking information related to the screeners.

The present invention's user GUI is built around an intuitive icon driven environment. Via the remote control (not shown), users will simply select (“click-on”) the icon of a screener that they wish to view on a TV 17, and then, watch the screener play out in its entirety. The remote control also allows the user to stop, pause, rewind, and fast forward through the selected screeners.

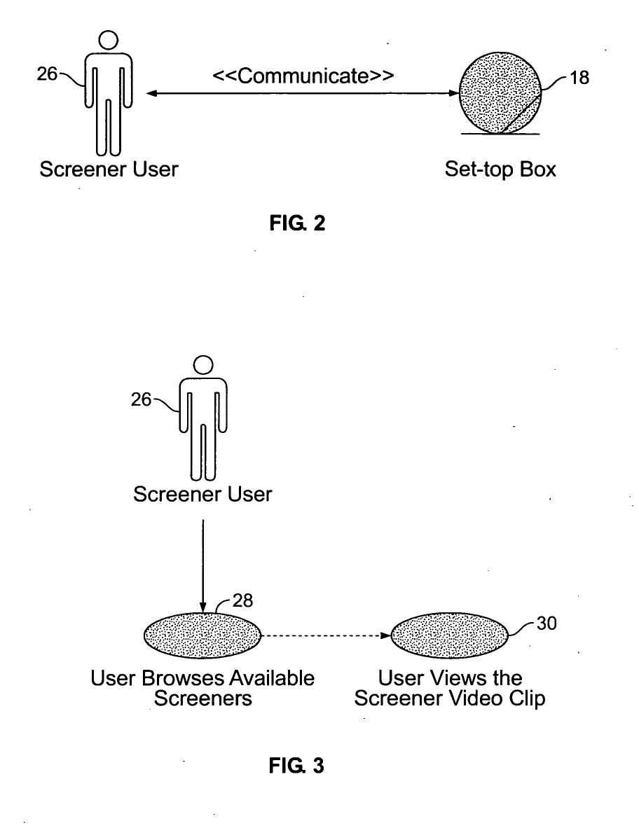

FIG. 2 illustrates a user 26 communicating with the set-top box 18. During the communication process between the user and the set-top box, the set-top box via the television 17 presents the user with icons representing available screener video clips via a menu screen (not shown) that lists the available screeners. The user highlights, via the remote control (not shown), e.g., an infrared remote control unit, an icon of a screener on the menu screen, and reads a short synopsis of the screener. Next, the user views the screener video clip, by pressing the “play” button (not shown) on the remote control while the clip icon is highlighted. The user can pause, fast forward (2×) and fast rewind (2×) the media playback of the screener using the remote control. If the user stops the playback, the set-top box will revert back to the menu screen. At the end of each media clip, the set-top box reverts back to the main menu screen. This screener selection process is depicted in FIG. 3, which illustrates a user that browses the available screeners (see item 28), and eventually selects and views a screener (see item 30).

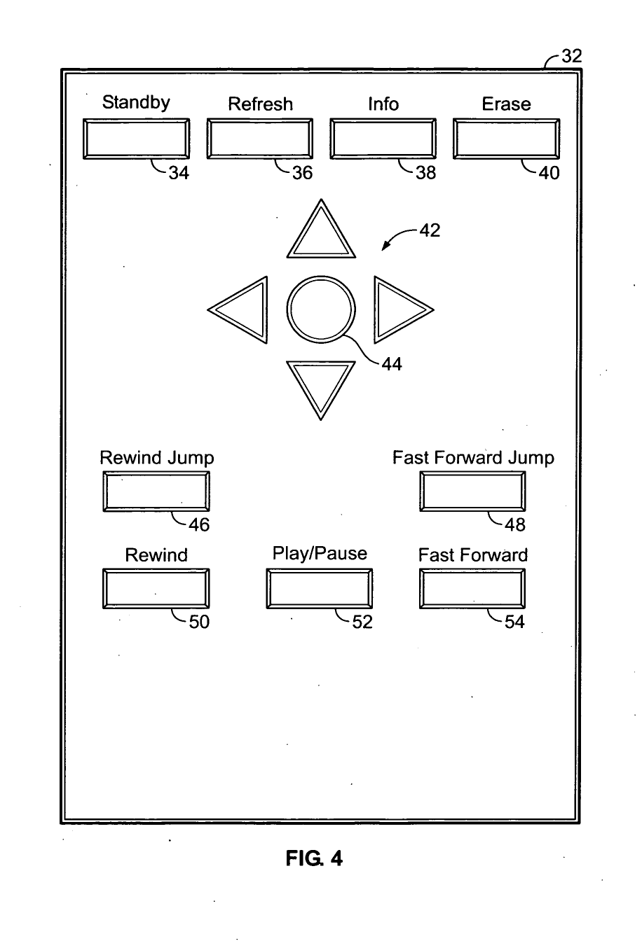

Referring to FIG. 4, the set-top box remote control functionality allows the user to interact with the set-top box 18 using the following buttons on the remote control 32 to perform the specific functionality: standby 34—the set-top box remains on, however, the standby button allows the user to put the set-top box in “sleep mode”; refresh 36—when pressed, this button will make a call to the server to refresh the set-top box; info 38—when pressed, this button provides information related to a screener; erase 40—when pressed, erases a screener; menu navigation or disc toggle 42—these buttons allow the user to select a screener, and to select various other functions, e.g., delete the screener; select/play 44—when pressed, the screener will begin to play; rewind jump 46—when pressed, the screener will automatically jump five minutes in reverse; fast-forward jump 48—when pressed, the screener will automatically jump five minutes forward; rewind (2×) 50—when pressed, the screener will rewind; play/pause 52—when pressed; the screener will pause, and when pressed again, the screener will resume playing; and fast-forward (2×) 54—when pressed, the screener will fast-forward.

Each set-top box 18 operates much like a commercial video appliance, and is compatible with many different formats, e.g., PAL and NTSC. In one embodiment, the set-top box is a miniature Wintel PC including hardware for consumer infra-red unit reception, with the following software components pre-installed: Apple Quicktime runtime, a driver for consumer infra-red reception, and a Java-based application that performs all tasks specific to screener operation including screener downloads, infra-red command interpretation, screener browsing, playback control, tracking information gathering, and self updates.

During use, the television 17 in combination with the set-top box 18 displays to the user a “What's New” screen (not shown) that displays the current screeners that have been deployed to the set-top box. Each screener has a preview image that includes the screener's title, a description of the screener, the screener's genre, the running time of the screener, and the following menu buttons: the info button, the save button, and the delete button. Also, a top-level menu is displayed that includes a play list screen link. Navigation through the menu elements is accomplished via the remote control 32. When the set-top box is in a standby state, the user presses a button on the remote control to “wake up” the set-top box.

The user can access a “Play List” screen (not shown) using the set-top box 18 from the “What's New” screen by pressing navigation buttons on the “What's New” screen and highlighting the “Play List” button. The set-top box then takes the user to the “Play List” screen, which is displayed on the set-top box. The “Play List” screen shows the following: a top-level menu and a middle region of the screen that contains a list of screeners. The top-level menu contains the following: buttons to sort the screeners by genre, run time, date, title, and saved screeners; buttons for navigation to other screens, e.g., a button to the “What's New” screen; and a button to delete selected screeners. The list of screeners in the middle region of the screen includes the following information: the screener title, the genre of the screener, the screener runtime, and a description of the screener. Each screener has the following menu buttons associated with it: info, save, and delete.

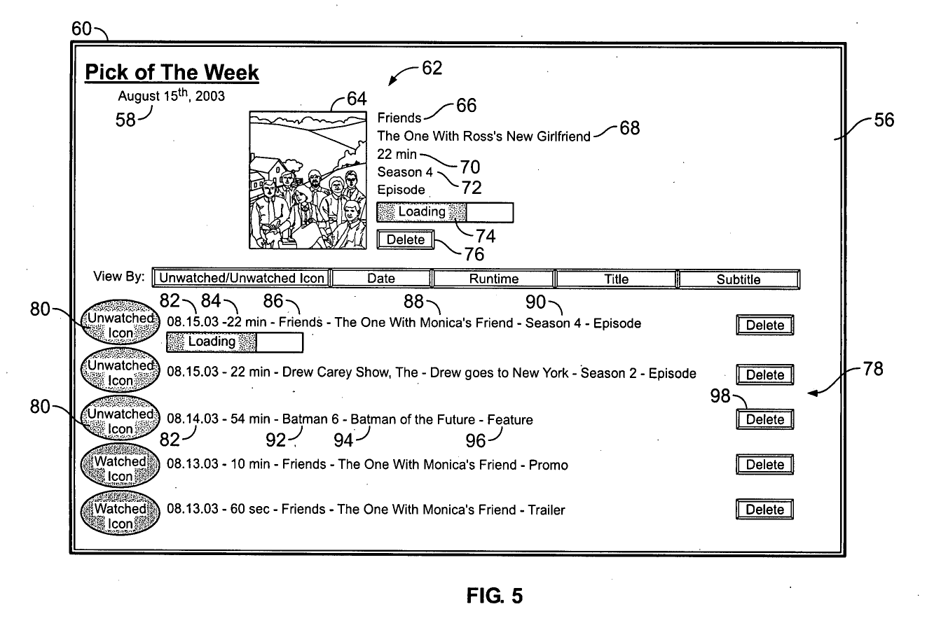

FIG. 5 is a printout of an example “Pick of The Week” screen 56 that can be displayed on the television 17 using the set-top box 18. The date 58 is shown in the upper left-hand corner 60 of the “Pick of The Week” screen. In the middle of the top portion 62 of the “Pick of the Week” screen, the following information, in the case where the screener is a TV episode, is displayed: a picture 64 related to the highlighted episode, the series name 66 of the episode, the episode's title 68, the episode's runtime 70, the season 72 associated with the episode, a window 74 that indicates when the episode is loading, and an icon 76 that can be selected to delete the episode. In the lower portion 78 of the “Pick of The Week” screen, information related to multiple episodes can be listed. In particular, lower portion includes an icon 80 that indicates whether the episode has been watched, the date 82 the episode was added to the “Pick of The Week” screen, the episode's runtime 84, the series name 86, the episode's title 88, and the season 90 associated with the episode.

Screeners other than TV episodes, e.g., feature movies, promos, and trailers, also can be listed in the “Pick of The Week” screen 56. If screeners other than TV episodes are included in the “Pick of The Week” screen, the lower portion 78 of the “Pick of The Week” screen displays the icon 80 indicating whether the screener has been watched, the date 82 the screener was added to the “Pick of The Week” screen, the screener's title 92 and subtitle 94, an indication of the screener type 96, and an icon 98 that can be selected to delete the screener from the screen.

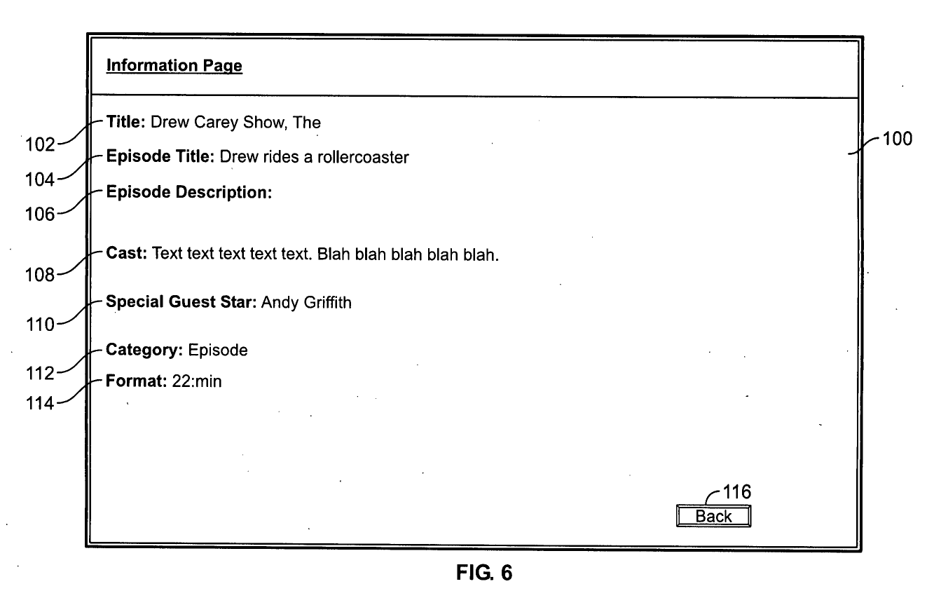

FIG. 6 is a printout of another example screen, an “Information Page” screen 100, that can be displayed on the television 17 using the set-top box 18. The “Information Page” screen includes information related to the screener. For example, in the case of a TV episode, FIG. 6 includes the title 102 of the series associated with the episode, the episode's title 104, a description of the episode 106, the episode's cast 108, special guest stars 110, the category of the screener 112, e.g., episode, and the format 114, e.g., the runtime. The “Information Page” screen also includes a “Back” icon 116, which when selected returns the user to a previous screen (not shown).

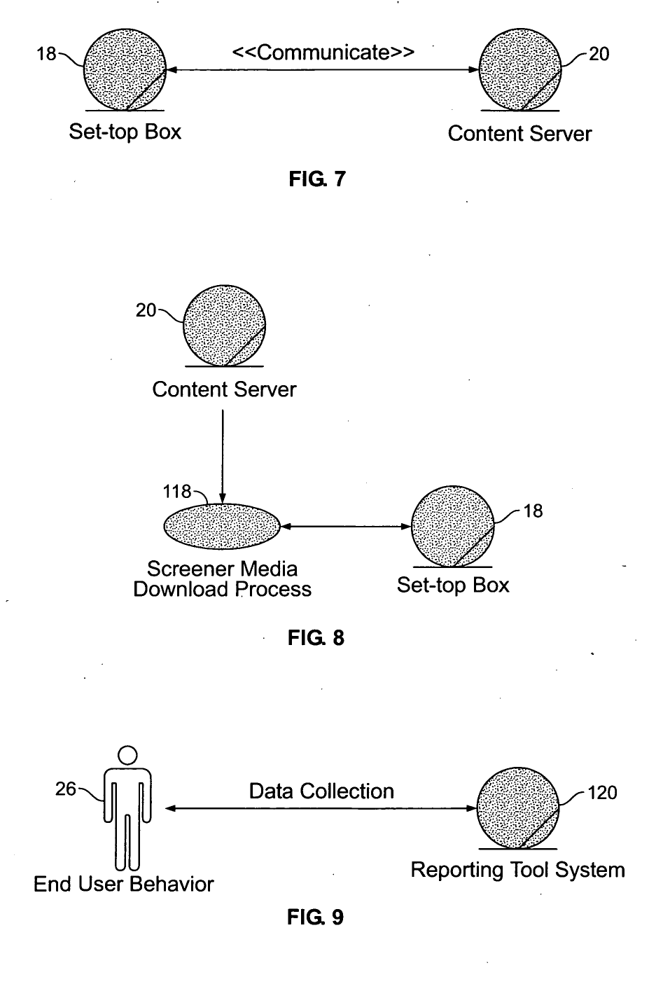

As discussed above, embodiments of the present invention allow for the tracking of a user's viewing patterns. FIG. 7 illustrates communication process between the set-up box 18 and the server 20, which provides for the process of tracking the user's viewing patterns. In particular, the server receives viewing pattern information from the set-top box. The set-top box collects the following: the calendar time of the start of the screener playback, the time of screener clip for each pause the user requested, and the calendar time of a stop requested by the user. A reporting tool system (not shown) included in the server stores this information that is used to characterize the user's viewing behavior for each screener. Capturing information, for example, which version of the screener the user likes, or user behaviors, e.g., if the user watched the screener and how much time the user spent watching the screener, is valuable information that could drive sales and revenue related to the screener.

FIG. 8 illustrates the set-top box 18 communicating with the server 20 via a screener download process (see item 118). Before the screener download process begins, a pending screener that already has not been downloaded to the set-top box is located in the server. After the screener download process, the screener is downloaded into the set-top box. During the screener download process, the following occurs: the set-top box connects to the server; the set-top box is authenticated; the server sends outstanding media files (if any) to the set-top box, based on the set-top box profile; the set-top box uploads viewing statistics complied since the last successful connection of the set-top box to the server; the server sends client software updates (if any) to the set-top box; the server sends the “next connection time advisory” information to the set-top box; and the set-top box disconnects from the server.

As the user 26 views the screener on the television 17, viewing information is tracked by the video delivery system 10. Information such as when the screener was played, and at what point the screener was paused and stopped are relayed back to the server. This allows future screeners to be tailored to the end users interests that are reflected in the tracked information. As illustrated in FIG. 9, the data regarding the end user's behavior is forwarded to the reporting tool system 120. The reporting tool system stores the end user's behavior information for each screener. In one embodiment of the present invention, an Oracle database (not shown) stores the user profiles, screener subscriptions, meta-data and tracking information related to the screener, and user choices.

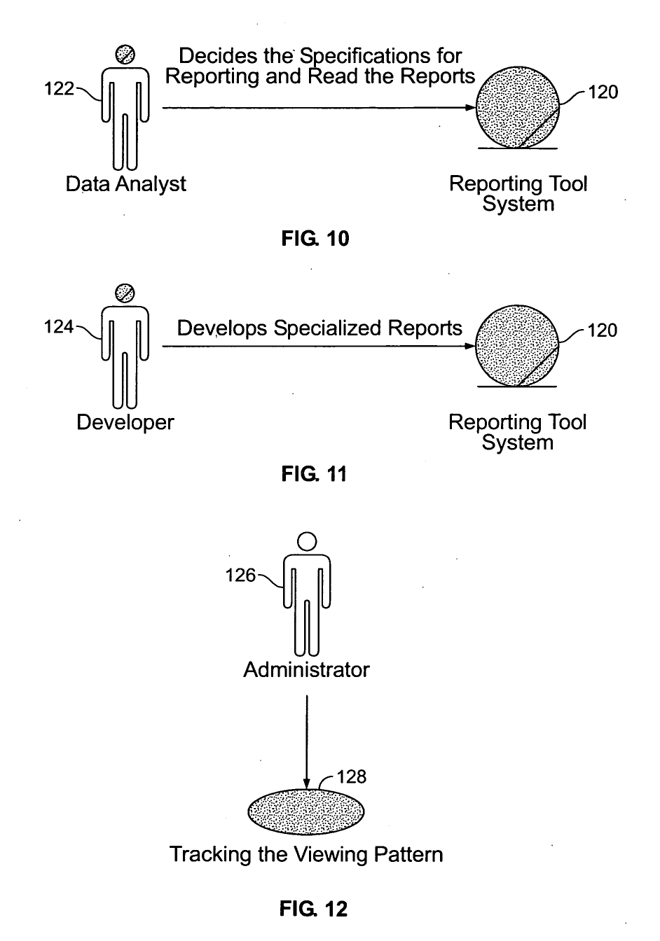

FIG. 10 illustrates the communication between a data analyst 122 and the reporting tool system 120. In particular, the data analyst examines the data that has been collected regarding the user's behavior, and then decides the requirements and specification needed for reports (not shown) that are generated based on the user's data. Once reports are generated, the data analyst reads the reports on a regular basis, e.g., on a daily, weekly, and/or monthly basis. The information included in the reports is used to improve end user services, and to increase profitability of the services provided by the video delivery system 10.

FIG. 11 illustrates the communication between a developer 124 and the reporting tool system 120. The developer develops specialized reports (not shown), more specifically, the developer writes programs to produce the required reports.

A web-based administration application (not shown) included in the video delivery system 10 provides a user interface to the data maintained at the RDBMS, so that administrator(s) 126, see FIG. 12, can easily update user profiles, subscriptions, reoccurring screeners, perform meta-data entry and compile viewing pattern reports (not shown). An administrator is an individual who is granted authority to maintain the user accounts and can access the screener media files. Thus, as illustrated in FIG. 12, a system administrator can track an end user's viewing patterns (see item 128).

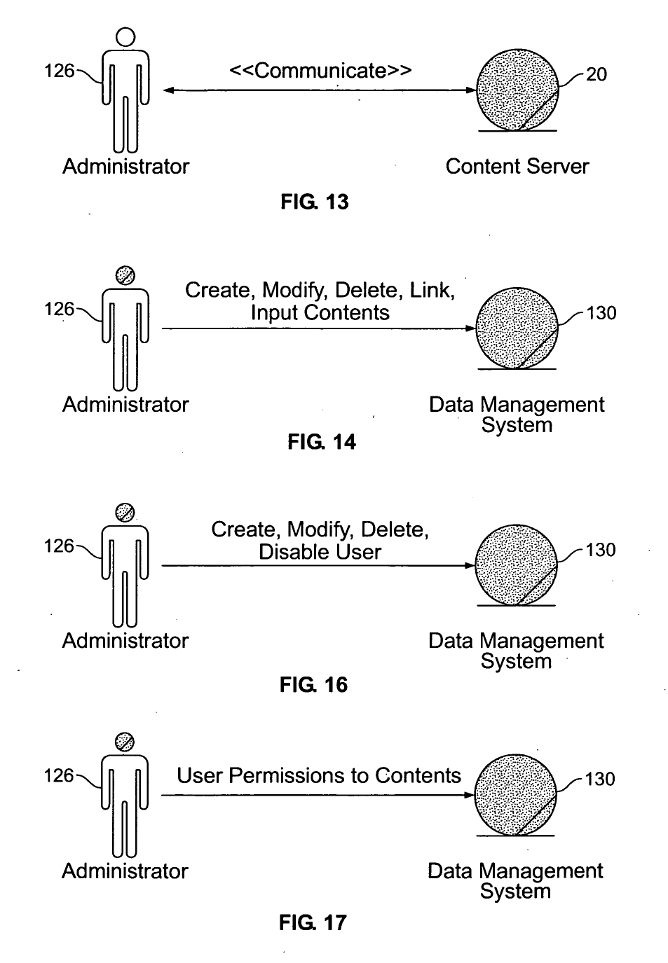

FIG. 13 illustrates the communication between the administrator 126 and the server 20. For example, system administrators can create, update, and disable user accounts; system administrators can subscribe or unsubscribe a user 26 to the distribution of a recurring screener series; system administrators can approve the distribution of newly digitized screeners; administrators can input a synopsis or other meta-data for each screener; and the system administrator can configure the system 10 to distribute a screener that is one of a recurring episode in a series to all subscribed users of that series. For each screener, the system transcodes the screener into an optimized format for screener distribution, stage the screener to a server, and input the file path to the administration web application. Also, the system administrator selects which set of users will have access to one-of programming clips, i.e., single programming clips. Embodiments of this web-based administration application utilize J2EE on IBM Websphere application servers (not shown).

In one embodiment, screener media (not shown) in DVCAM tape format is transcoded into MPEG4 format. Next, the screener clips are staged to the server 20. The screener clips are confirmed as functioning properly. Then, the system administrator 126 is notified so that meta-data attachments can begin, and the administrator can schedule the delivery of the media to the end users 26.

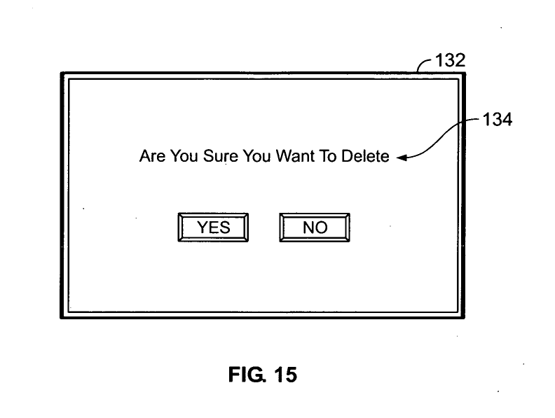

Referring to FIG. 14, the administrator 126 utilizes a data management system 130 that is stored in the server 20 to manage security related to the screeners. The flow of events for managing security of each screener is as follows. First, the administrator goes to the “Manage Users” page (not shown) of the data management system, and the administrator starts by choosing a user 26 or content, e.g., product or screener, from the list of available content. Second, the administrator selects an operation to be performed, e.g., add; delete. If the operation is an add, a list of available contents or users will be displayed, and the administrator will make selections from the list. If the operation is a delete, the administrator makes selections on a list of content that can be accessed by a given user or a list of users who have access to a given piece of content. Next, for all operations, the data management system displays a message asking “Are you sure?” (see example screen 132 including a displayed message 134 in FIG. 15), the administrator confirms that the operation should be performed, and the data management system performs the operation.

FIG. 14 illustrates the flow of communication between the administrator 126 and the data management system 130. In particular, the FIG. 14 illustrates the situation where the administrator creates, modifies, deletes, links, and/or inputs content to the data management system. When content is created, modified, and/or deleted, the following flow of events applies: the administrator access the “Manage Contents” page (not shown) of the data management system; the administrator selects a request to be performed, e.g., create, modify, or delete a product or a screener; if the request is “create a new product or screener,” the administrator will require the entry of the new information (including scheduling to be viewed by the end user 26), otherwise, the administrator selects a particular product or screener from the list of available products or screeners to be modified or deleted; if the request is to modify, the current information of the given product or screener is shown, and the administrator then updates the information; next, for all requests, the data management system displays a message asking “Are you sure?”; the user acknowledges the request; the data management system performs the request; and the system returns a “done” message. The product can have parameters including “product type” and “category.”

In the case where a link is created or deleted, the following flow of events occurs: the administrator 126 goes to the “Manage Contents” page (not shown) of the data management system 130; the administrator selects a request to be performed, e.g., to create or delete a link between a screener and a product, the administrator can start from either a screener or a product; if the request is “create a new link,” the administrator selects new content from the list of available contents to be linked with the starting content; if the request is “delete link,” the administrator selects links from the list of available links associated with the starting screener or product and click-on the “delete link” icon; next, for all requests, the data management system displays a message asking “Are you sure?”; the user acknowledges the request; the data management system performs the request; and the system returns a “done” message.

In the case where the screener is input from a remote source (not shown), the following flow of events apply: the administrator 126 accesses the “Manage Contents” page (not shown) of the data management system 130; the administrator selects a request to be performed, e.g., load a media file or input data from the remote source for a screener; the administrator first can select one of the screeners to start; if the request is to load, the administrator selects a data file located on the administrator's local PC 22 to be loaded into the server 20; next, the data management system displays a message asking “Are you sure?”; the user acknowledges the request; the data management system performs the request; and the system returns a “done” message.

FIG. 16 illustrates the case where the administrator 126 communicates with the data management system 130 to create, modify, delete, and/or disable a user's account. In this case, the following flow of events applies: the administrator goes to the “Manage Users” page (not shown) of the data management system, the administrator selects a request to be performed, e.g., to create, modify, delete, or disable a user account; if the request is to create a new user account, the administrator will require the entry of a new user's information, otherwise, the administrator will select the user 26 from a list of available users to perform a request to modify, delete, or disable the user; if the request is to modify a user's account, the current user's information is shown, and the administrator can then modify the user information; next, for all requests, the data management system displays a message asking “Are you sure?”; the user acknowledges the request; the data management system performs the request, and the system returns a “done” message.

FIG. 17 illustrates the case where the administrator 126 communicates with the data management system 130 to grant security access to the user 26 for particular contents (not shown). In particular, the following flow of events occur: the administrator accesses the “Manage Users” page (not shown) of the data management system; first, the administrator starts with choosing the user or content (product or screener) from the list of available users or content; the administrator selects a request to be performed, e.g., add or delete; if the request is add, a list of available contents or users is displayed, and the administrator makes a selection from the list; if the request is delete, the administrator makes a selection on a list of contents that can be accessed by a given user or a list of users that have access to a given content; next, for all requests, the data management system displays a message asking “Are you sure?”; the user, acknowledges the request; and the data management system performs the request.

In other embodiments, the server farm 20 and/or the system administrator computer 22 are configured to transmit a personalized software patch or configuration patch to an individual set-top box 18 via the Internet 16. After receiving the patch, the targeted set-top box is configured to apply the patch automatically. Also, embodiments of the set-top box include a heartbeat mechanism, e.g., the generation of a periodic signal, that can be sensed remotely by the server farm and/or the system administrator computer. By sensing the heartbeat mechanism, the server farm and/or the system administrator computer can detect if any of the deployed set-top boxes are not coupled to the Internet. The ability to transmit a personalized patch to an individual set-top box, and the ability to sense whether a set-top box is coupled to the Internet, advantageously facilitate the usability and manageability of the set-top boxes.

In additional embodiments, hidden configuration menu screens (not shown) can be displayed on the television 17 using the set-top box 18. These hidden configuration menu screens are accessible to a field officer, e.g., a technician working on a set-top box, so that the field officer can configure the set-top box on the spot at the user's location to accommodate a user's specific preferences and network parameters. Access to the hidden configuration menu screen can be facilitated by using an infra-red controlled user interface (not shown).

Advantageously, the present invention 10 provides a low-cost and secure means for distributing video content and tracking user behavior to provide both pre-sale and post-sale data to improve video distribution service to end users 26.

The foregoing detailed description of the present invention is provided for purposes of illustration, and it is not intended to be exhaustive or to limit the invention to the particular embodiments disclosed. The embodiments can provide different capabilities and benefits, depending on the configuration used to implement the key features of the invention. Accordingly, the scope of the invention is defined only by the following claims.

What is claimed is:

1. A system that is configured to be coupled to the Internet, the system comprising:
a. a server that stores a media element and that is configured to be coupled to the Internet;
b. a monitor that is configured to display a copy of the media element; and
c. a video appliance that is coupled to the monitor and configured to be coupled to the Internet;
d. wherein:
i. the server is configured to transmit the copy of the media element to the video appliance via the Internet,
ii. the video appliance is configured to receive the copy of the media element, and
iii. the video appliance is configured to prompt the monitor to display the copy of the media element for viewing by a user.

2. The system according to claim 1, wherein the media element is selected from the group consisting of a feature movie, a movie promotion, a movie trailer, and a video clip associated with a television program.

3. The system according to claim 1, further comprising a remote control that is configured to communicate with the video appliance.

4. The system according to claim 3, wherein the user uses the remote control to perform a task selected from the group consisting of playing the copy of the media element, pausing the display of the copy of the media element, fast forwarding the display of the copy of the media element, rewinding the display of the copy of the media element, stopping the display of the copy of the media element, and selecting a copy of another media element for display on the monitor.

5. The system according to claim 1, wherein the video appliance is configured to prompt the monitor to display a screen that includes a graphical user interface.

6. The system according to claim 5, wherein the user utilizes the graphical user interface to select the copy of the media element for viewing or deletion.

7. The system according to claim 5, wherein the graphical user interface includes an icon that is associated with the copy of the media element.

8. The system according to claim 7, wherein the graphical user interface further includes information selected from the group consisting of a description of the media element, a title of the media element, a runtime of the media element, a genre of the media element, and a date associated with the media element.

9. The system according to claim 1, wherein the video appliance stores information related to the user's viewing behavior for each copy of a media element viewed by the user.

10. The system according to claim 9, wherein the information related to the user's viewing behavior is selected from the group consisting of a name of the media element that was selected by the user for display on the monitor, a time when the copy of the media element was displayed on the monitor, a time when the display of the copy of the media element was paused, and a time when the display of the copy of the media element was stopped.

11. The system according to claim 9, wherein the video appliance transmits the information related to the user's viewing behavior of the copy of the media element to the server via the Internet.

12. The system according to claim 11, wherein the server receives and stores the information related to the user's viewing behavior of the copy of the media element.

13. The system according to claim 12, wherein a data analyst examines the information stored in the server related to the user's viewing behavior of the copy of the media element, and generates a report based on the information related to the user's viewing behavior of the copy of the media element.

14. The system according to claim 1, wherein the server is configured to transmit a patch to the video appliance, and the video appliance is configured to automatically apply the patch.

15. The system according to claim 1, wherein the video appliance includes a heartbeat mechanism, and the server is configured to sense the heartbeat mechanism.

16. The system according to claim 1, further comprising a system administrator computer that is coupled to the Internet and that is used by a system administrator to control the access of the video appliance to a copy of the media element that is stored in the server.

17. The system according to claim 16, wherein the system administrator uses the system administrator computer to perform a task selected from the group consisting of storing a new media element in the server, creating a new media element, modifying a media element that is already stored in the server, deleting a media element that was stored in the server, creating a user account, updating a user account, disabling a user account, and managing a user's access to a copy of a media element that is stored in the server.

18. The system according to claim 16, wherein the system administrator computer is configured to transmit a patch to the video appliance, and the video appliance is configured to automatically apply the patch.

19. The system according to claim 16, wherein the video appliance includes a heartbeat mechanism, and the system administrator computer is configured to sense the heartbeat mechanism.

20. The system according to claim 1, wherein the system further includes a security feature selected from the group consisting of security management, authentication, and encryption that is used to protect the copy of the media element from piracy during the transmission of the copy of the media element from the server to the video appliance.

21. A system that is configured to be coupled to a network, the system comprising:
a. a server that stores a media element and that is configured to be coupled to the network;
b. a monitor that is configured to display a copy of the media element;
c. a video appliance that is coupled to the monitor and configured to be coupled to the network;
d. wherein:
i. the server is configured to transmit a copy of the media element to the video appliance via the network,
ii. the video appliance is configured to receive the copy of the media element,
iii. the video appliance is configured to prompt the monitor to display a screen that includes a graphical user interface,
iv. the graphical user interface is configured to be utilized by a user to select the copy of the media element for display on the monitor,
v. the video appliance is configured to prompt the monitor to display the selected copy of the media element for viewing by the user,
vi. the video appliance is configured to store information related to the user's viewing behavior of the copy of the media element, and
vii. the video appliance is configured to transmit the information related to the user's viewing behavior of the copy of the media element to the server via the network.

22. The system according to claim 21, wherein the network is the Internet.

23. The system according to claim 21, further comprising a remote control that is configured to communicate with the video appliance.

24. The system according to claim 23, wherein the user uses the remote control to perform a task selected from the group consisting of playing the copy of the media element, pausing the display of the copy of the media element, fast forwarding the display of the copy of the media element, rewinding the display of the copy of the media element, stopping the display of the copy of the media element, and selecting a copy of another media element for viewing on the monitor.

25. The system according to claim 21, wherein the information related to the user's viewing behavior is selected from the group consisting of a name of the media element that was selected by the user for display on the monitor, a time when the copy of the media element was displayed on the monitor, a time when the display of the copy of the media element was paused, and a time when the display of the copy of the media element was stopped.

26. A method for the delivery of a copy of a media element via the Internet, the method comprising:
a. providing a server that stores the media element and that is coupled to the Internet;
b. providing a monitor;
c. providing a video appliance that is coupled between the Internet and the monitor;
d. using the server to generate a copy of the media element;
e. transmitting the copy of the media element from the server to the video appliance via the Internet; and
f. using the video appliance to prompt the monitor to display the copy of the media element on the monitor for viewing by a user.

27. The method according to claim 26, further comprising:
a. providing a remote control that is configured to communicate with the video appliance; and
b. using the remote control to select the copy of the media element to be displayed on the monitor.

28. The method according to claim 26, further comprising:
a. displaying a screen on the monitor that includes a graphical user interface; and
b. using the graphical user interface to select the copy of the media element that is to be displayed on the monitor.

29. The method according to claim 28, wherein the screen includes a hidden configuration menu screen that is accessible by a field officer.

30. The method according to claim 26, further comprising storing information related to the user's viewing behavior for each copy of a media element that is displayed on the monitor.

31. The method according to claim 30, further comprising transmitting the information related to the user's viewing behavior for each copy of a media element from the video appliance to the server.

32. The method according to claim 31, further comprising analyzing the information related to the user's viewing behavior for each copy of a media element that is transmitted from the video appliance to the server.

33. The method according to claim 31, further comprising generating reports using the information related to the user's viewing behavior for each copy of a media element that is transmitted from the video appliance to the server.

34. The method according to claim 26, further comprising using the server to authenticate the video appliance before transmitting the copy of the media element from the server to the video appliance.
